(19) United States
(12) Patent Application Publication
(10) Pub. No.: US 2005/0216834 A1
(43) Pub. Date: Sep. 29, 2005

(54) Method, apparatus, and computer-readable medium for dynamically rendering a user interface menu

(75) Inventor: Ye Gu, Seattle, WA (US)

Correspondence Address: Leonard J. Hope;Merchant & Gould P.C., P.O. Box 2903, Minneapolis, MN, 55402-0903, US

(73) Assignee: Microsoft Corporation

(21) Appl. No.: 10/811,532

(22) Filed: Mar. 29, 2004

(51) Int. Cl. G06F 17/21

(52) U.S. Cl. 715/522; 715/517; 715/513

(57) ABSTRACT

A method, apparatus, and computer-readable medium are provided for dynamically generating a user interface menu. According to the method, a menu definition file is stored that contains data describing one or more menu items to be displayed on the menu. A view definition file is stored separate from the menu definition file that contains data describing how the menu should appear when displayed. The contents of the view definition file and the menu definition file may be utilized together to dynamically display the menu.

### TECHNICAL FIELD

The invention generally relates to the field of user interfaces and, more specifically, to the field of dynamically generating user interface menus.

### BACKGROUND OF THE INVENTION

As the number of wireless telephone service providers has increased, so has the level of competition for wireless customers. In order to better compete for customers in the marketplace, wireless service providers continually seek out ways to differentiate their products and services from the products and services available from other providers in the marketplace. For example, wireless service providers may sell wireless telephones that include user interface menus that are customized for the provider. Such menus may be utilized to provide logos or other graphics for the provider, to advertise the services available from the provider, such as text messaging or wireless Internet access, and to provide quick access to the native features of the telephone, such as a contacts list or an electronic mail application.

In order to provide a custom user interface menu on a wireless telephone, a wireless service provider will typically work closely with the original equipment manufacturer (“OEM”) of the telephone. Through close collaboration, a user interface menu application program can be designed and programmed into the phone that provides access to the available services and phone functions. The user interface menu application program is typically programmed into the firmware of the telephone at the factory.

Because the user interface menu application program for the wireless telephone is programmed at the factory, it can be very difficult to change the layout or content of the menu. This may be desirable, for instance, if a wireless service provider implements a new service and desires to add a menu item for the new service on the wireless telephone user interface menu. Additionally, for these same reasons, it can be extremely difficult for a wireless provider to modify the “look and feel”, such as the colors, fonts, and icons utilized to display the user interface menu. Because the menu is programmed into the firmware at the factory, it can be extremely complicated to re-program the firmware with a new user interface menu.

It is with respect to these considerations and others that the various embodiments of the present invention have been made.

### SUMMARY OF THE INVENTION

In accordance with the present invention, the above and other problems are solved by a method, apparatus, and computer-readable medium for dynamically rendering a user interface menu based on the contents of several extensible markup language (“XML”) data files. The XML data files define the menu and various presentation styles for displaying the menu independently of one another. The XML data files may be updated over-the-air without requiring any modification to the underlying program code for displaying the menu from the contents of the files.

According to one aspect of the invention, a method is provided for dynamically generating a user interface menu. According to the method, a menu definition file is stored that contains data describing one or more menu items to be displayed on the menu. A view definition file is stored separate from the menu definition file that contains data describing how the menu should appear when displayed. The contents of the view definition file and the menu definition file may be utilized together to dynamically display the menu.

According to other aspects of the invention, the menu may include an items component for displaying each of the menu items. The menu items identify programs, uniform resource locators (“URL”), native functions available from a handheld device, macros, and other items of interest to a user of a handheld device. The items may also include folders for navigating to other nodes in the menu. The menu may also include a preview component for displaying a preview corresponding to a currently selected item in the menu. The preview, for instance, may include additional information in text or graphic format pertaining to the currently selected item. The menu may also include a category component for displaying information corresponding to a group of menu items.

According to aspects of the invention, the menu definition file stores data for each of the menu items that identifies one or more graphic images that should be displayed for the menu item in the items component. The menu definition file may also store data identifying a graphic that should be displayed in the preview component when an item is selected. The menu definition file may also store a text label to be displayed for each item in the items component and in the preview component. The menu definition file may also store data identifying an action to be performed if a request to execute a selected menu item is received.

According to yet other aspects of the invention, the view definition file stores data defining a style to be utilized when displaying the menu defined within the menu definition file. The style may include the identity of a background image to be displayed within the items component, an on-screen pixel position for each of the menu items within the items component, and details regarding how navigation should occur between each of the items. Other types of data may be stored in the view definition file defining the on-screen presentation user interface for the menu defined in the menu definition file.

The invention may be implemented as a computer process, a computing system, or as an article of manufacture such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. The computer storage media may also encode one or more XML data structures for use in dynamically displaying a user interface menu.

These and various other features, as well as advantages, which characterize the present invention, will be apparent from a reading of the following detailed description and a review of the associated drawings.

### BRIEF DESCRIPTION OF THE DRAWINGS

FIG. 1 is a computer system architecture diagram illustrating the various components of a wireless telephone utilized in the several embodiments of the invention;

FIGS. 2A-2B are user interface diagrams showing several illustrative user interface menus generated by the embodiments of the present invention;

FIG. 3 is a block diagram illustrating aspects of an items component, an item layout, and a focus layout utilized to create a user interface menu in an embodiment of the present invention;

FIGS. 4A-4B are block diagrams illustrating aspects of a preview component, a description component, and a scroll bar component utilized within a user interface menu provided by the embodiments of the present invention;

FIGS. 5A-5B are block diagrams showing illustrative arrangements of an items component, items, and a preview component according to various embodiments of the invention;

FIG. 6 is an XML hierarchy diagram showing aspects of a <menuitems> XML element provided by and utilized in the various embodiments of the invention;

FIG. 7 is an XML hierarchy diagram showing aspects of a <menulayout> XML element provided by and utilized in the various embodiments of the invention;

FIG. 8 is an XML hierarchy diagram showing aspects of a <menu> XML element provided by and utilized in the various embodiments of the invention;

FIGS. 9A-9C are XML hierarchy diagrams showing aspects of <preview>, <category>, and <scrollbar> XML elements provided by and utilized in the various embodiments of the invention;

FIG. 10 is a flow diagram illustrating a process for dynamically generating a user interface menu according to one embodiment of the invention.

### DETAILED DESCRIPTION OF THE INVENTION

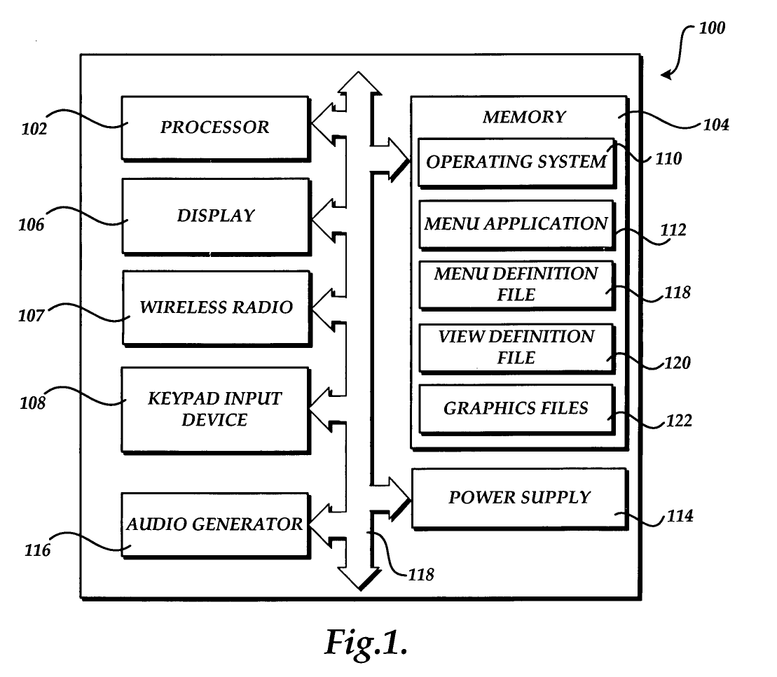

Referring now to the drawings, in which like numerals represent like elements, various aspects of the present invention will be described. In particular, FIG. 1 and the corresponding discussion are intended to provide a brief, general description of a suitable computing environment in which embodiments of the invention may be implemented. While the invention will be described in the general context of program modules that execute in conjunction with program modules that run on an operating system on a handheld telephone or computer, those skilled in the art will recognize that the invention may also be implemented in combination with other types of computer systems and program modules.

Generally, program modules include routines, programs, components, data structures, and other types of structures that perform particular tasks or implement particular abstract data types. Moreover, those skilled in the art will appreciate that the invention may be practiced with other computer system configurations, including various classes of hand-held computing devices, wireless telephones, personal digital assistants, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

With reference to FIG. 1, an illustrative system for implementing the invention includes a wireless telephone 100. The wireless telephone 100 has a processor 102, a memory 104, a display 106, and a may include a keypad input device 108. The keypad 108 may include a numeric keypad and additional buttons for performing navigation and selection functions. The wireless telephone 100 also has a wireless radio 107 for communicating with a wireless voice and data telephone network. The display 106 may comprise a backlit thin-film transistor liquid crystal display or other type of display suitable for operation in a handheld device.

The handheld wireless telephone 100 has a power supply 114, which is implemented as one or more batteries. The power supply 114 may further include an external power source that overrides or recharges the built-in batteries, such as an AC adapter or a powered docking cradle. The handheld wireless telephone 100 may also include an audio generator 116 for generating audio output to be played back on a speaker contained within the handheld device 100. Each of the conventional components 102-116 of the handheld wireless telephone 100 may be interconnected through a bus 118 for transmitting data and power signals.

The memory 104 generally includes both volatile memory (e.g., random access memory (“RAM”)) and non-volatile memory (e.g., read-only memory (“ROM”)) and comprises a computer-readable media for providing non-volatile storage for the telephone 100. Although the description of computer-readable media contained herein refers to one or more solid state memory devices, it should be appreciated by those skilled in the art that computer-readable media can be any available media that can be accessed by the telephone 100.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the telephone 100.

An operating system 110 is resident in the memory 104 and executes on the processor 102. The handheld wireless telephone 100 includes an operating system 110 such as the “WINDOWS MOBILE SMARTPHONE” operating system from MICROSOFT CORPORATION. It should be appreciated that another operating system suitable for operating a wireless telephone, a handheld computer, or a desktop computer may be utilized.

According to various embodiments of the invention, the telephone 100 may operate in a networked environment using logical connections to remote computers through a wireless data network connected to the Internet. It should be appreciated that the wireless telephone 100 may also be utilized to connect to other types of networks and remote computer systems. It should also be appreciated that the software and data components stored on the wireless telephone 100 may be periodically updated through a connection to the Internet or other type of data network. In particular, an updated version of the view definition file 120 and an updated version of the menu definition file 118 may be installed on the phone via a wireless connection, via desktop synchronization software, or via a memory card or other storage medium.

One or more application programs may be loaded into the memory 104 and execute on the operating system 110. Examples of applications include e-mail programs, scheduling programs, PIM (personal information management) programs, word processing viewer programs, spreadsheet viewer programs and so forth. Another example of an application program is a web browser program module such as the “POCKET INTERNET EXPLORER” web browser application program from MICROSOFT CORPORATION or another web browser.

According to embodiments of the invention, a menu application program 112 is provided that also executes on the operating system 110. As will be described in greater detail herein, the menu application 112 is operative to provide a user interface menu for accessing the native functions of the telephone 100 and for accessing services provided by a network service provider. The menu application 112 provides a great deal of flexibility in the design and layout of the user interface menu and allows menus to be created utilizing a grid format, a list format, or another type of layout for the items in the menu. Moreover, because the data defining the menu, the data defining the appearance of the menu, and the menu application program 112 are decoupled, menu items may be added or removed, different visual styles may be applied to the menu, and other modifications may be made to the user interface menu without modifying the telephone 100.

According to one embodiment, the menu application program 112 is a standalone application that executes on the operating system 110. However, the functionality provided by the menu application program 112 may be integrated into the operating system 110. The menu application program 112 includes a core rendering engine for building and displaying the user interface menu and for allowing a user to navigate through the menu. The menu application 112 also includes a simple shell hosting the rendering engine. The core rendering engine takes as input two XML documents that represent menu data and a presentation user interface, respectively. In particular, the data defining the menu is stored in the menu definition file 118 and the data defining the presentation for the user interface menu is stored in the view definition file 120.

Based on the contents of the menu definition file 118, the view definition file 120, and one or more graphics files 122 referenced in the view definition file 120, the menu application 112 dynamically generates the user interface menu for the telephone 100. The menu application 112 also receives user input for navigating the menu. If a user selects an item in the menu, the menu application 112 returns a shortcut to the item that the user has selected. The shortcut may then be executed within the shell to provide the functionality desired by the user. When execution of the shortcut has completed, control is returned to the menu application 112 where the menu may again be displayed and input received. Additional details regarding the operation of the menu application 112 and the contents of the menu definition file 118 and the view definition file 120 will be provided below.

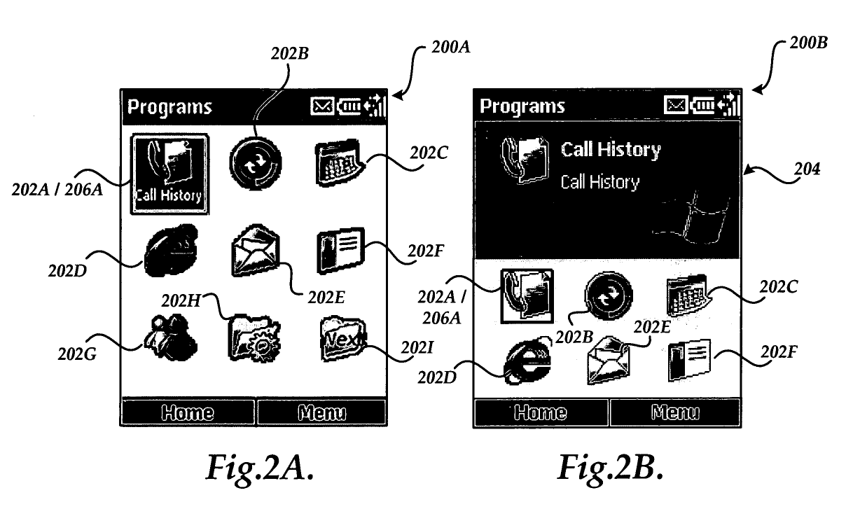

Referring now to FIGS. 2A-2B, several user interface diagrams showing several illustrative user interface menus generated by the embodiments of the present invention will be described. FIG. 2A shows an illustrative screen display 200A of the telephone 100. The screen display 200A includes a full screen user interface menu provided by the menu application 112. In particular, a number of user interface menu items (“items”) 202A-202I are displayed.

Each of the items 202A-202H represents functionality available through the telephone 100 when selected. The item 202A provides call history, the item 202B provides access to a synchronization application, the item 202C provides access to a calendar application program, the item 202D provides access to a web browser application, the item 202E provides access to an electronic mail application, the item 202F provides access to a contacts database, the item 202G provides access to an instant messaging application program, and the item 202H provides access to a settings control panel. The item 202I provides access to another screen of menu items when selected. It should be appreciated that items may comprise either selectable items or folders. Folders may include selectable items or other folders. Additionally, it should be appreciated that the functionality provided by the various items described herein is merely illustrative and that virtually any type of program, uniform resource locator, macro, file, or link may be executed in response to the selection of an item within the menu.

The menu application 112 also provides functionality for allowing a user to navigate between the various items utilizing a keypad. To facilitate navigation, a “focus” may be displayed around or over a currently selected item. The focus shows which of the menu items is currently selected by visually drawing out that item through highlight, border, pop-up, animation or some combination of the above. For instance, as shown in FIG. 2A, the item 202A is indicated as the currently selected item through the focus 206B. In this case, the focus represents a graphic image drawn over the currently selected item 202A. Additional details regarding the implementation of the focus will be described in greater detail below.

FIG. 2B shows a screen display 200B that includes a different view of the same menu presented in FIG. 2A. In FIG. 2B, only the items 202A-202F are displayed. The additional items may be reached by selecting a page down key or through scrolling of the display. The screen display 200B also includes a preview component 204. The preview component 204 provides additional data regarding the currently selected item. For instance, in FIG. 2B, the item 202A is selected and the focus 206A is shown over this item. Moreover, the preview component 204 shows an icon, the name, and a text description for the item 202A. It should be appreciated that the contents of the preview component 204 changes based upon the currently selected item. As shown in both FIGS. 2A and 2B, “soft keys” may be provided for navigating back to the menu while in a program and for navigating to the root level of the menu.

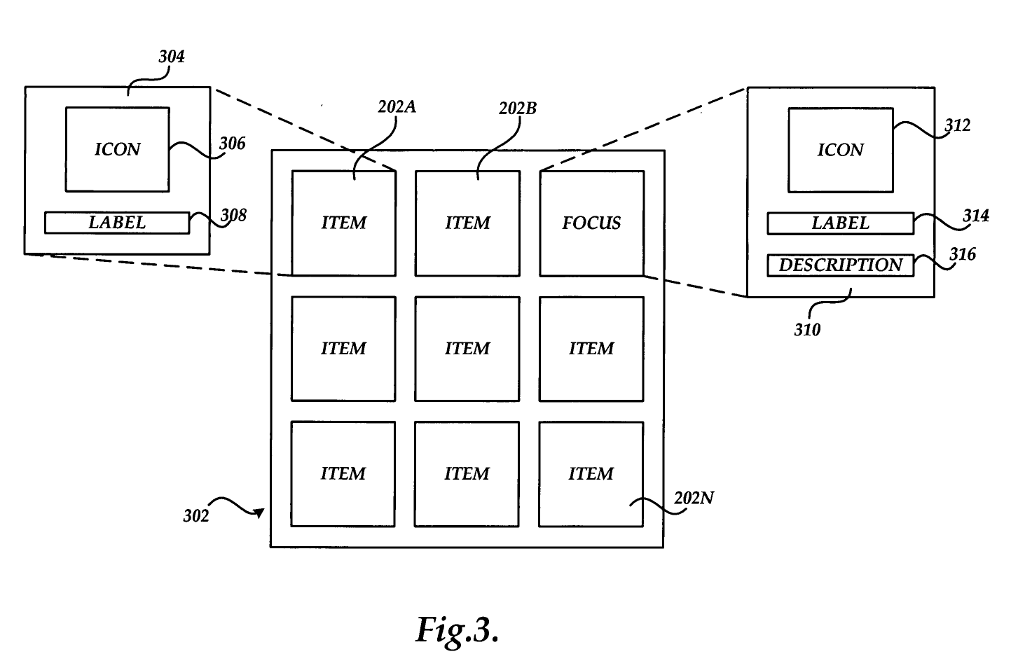

Turning now to FIG. 3, a block diagram illustrating aspects of an the various components utilized to create a user interface menu in an embodiment of the present invention will be described. In order to create a user interface menu, the menu data is separated from the menu's presentation user interface. A menu's data is the nested hierarchy of items in the menu along with their attributes (e.g. name or icon graphics). The presentation user interface for the menu is comprised of the menu layout and the menu navigation. The layout defines how the items of a menu at every level should be placed on screen. Additionally, the layout defines how items should be divided into pages if all of the menu items will not fit onto one screen. Navigation defines how a user moves the selection (i.e. focus) among the items (e.g. from item to item and if needed from page to page).

The menu layout is comprises of a number of different items. In particular, as shown in FIG. 3, the menu layout includes an items component 302. The items component 302 specifies an area of the screen inside of which key content (icon, label, etc.) of menu items is displayed. The items component 302 contains an item layout 304, a focus layout 310, positions of the items 202A-202N, and pagination. The item layout 304 defines how various elements that make up a menu item are placed inside of a bounding box. There are three elements in the item layout 304: a background image, an icon 306 and a text label 308. The focus layout defines how various elements that make up the focus are placed inside of a bounding box. There are four elements in the focus layout: a background image, an icon 312, a text label 314, and a text description 316.

Item positions define where the menu items 202A-202N are placed on the screen and how big of an area they occupy. Implicitly, the item positions also define where the focus should be displayed when an item is selected. The focus centers around and lies on top of the currently selected item when possible. The size of the focus may be bigger than the size of the item to which it pertains. If a menu at a particular level has more items than will fit onto a single display screen, pagination defines how to move between on screen and off screen items or pages. Pagination also specifies whether page scrolling is automatic and the keys that may be utilized for page up and page down operations.

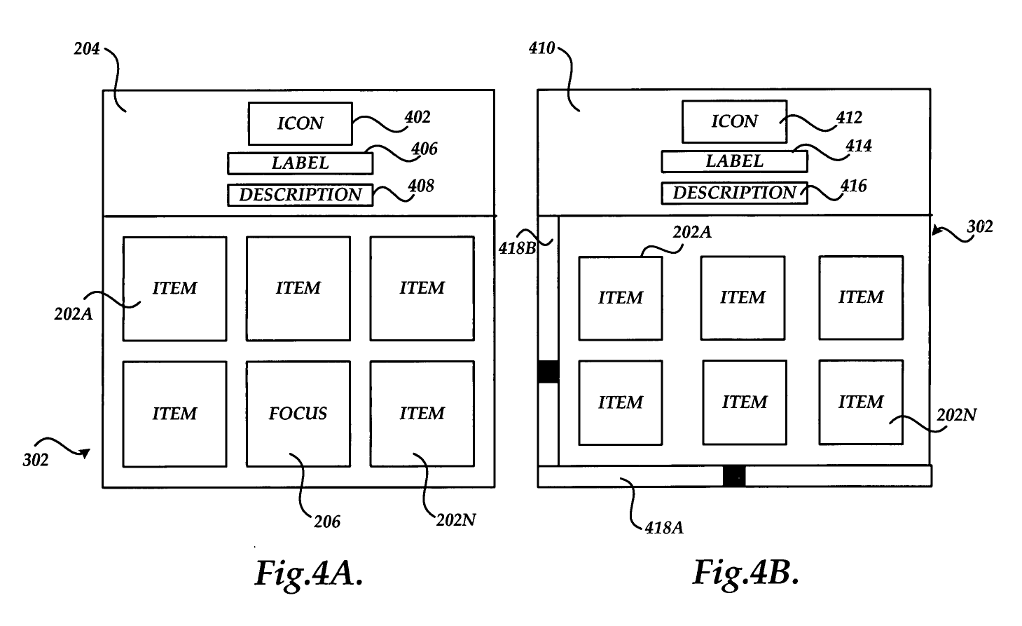

In order to represent a rich variety of menu designs, the presentation user interface supports more than just items components. In particular, according to embodiments of the invention, the menu supports the use of a preview component, a category component, and a scrollbar component. FIGS. 4A-4B illustrate aspects of a preview component, a category component, and a scroll bar component utilized within a user interface menu. In particular, FIG. 4A shows an items component 302 including items 202A-202N. One of the items is selected and is indicated by the focus 206.

As shown in FIG. 4A, the menu also includes a preview component 204. As discussed briefly above with reference to FIG. 2B, the preview component 204 defines a screen area that is used to show more detailed information on the currently selected menu item. In particular, the preview component 204 includes an icon 402, a text label 404, and a text description 406. The preview component 204 is similar to the focus, except that the preview component 204 does not move from item to item. Rather, the preview component 204 is statically positioned on the screen.

FIG. 4B illustrates the items component 302 along with a category component 410 and two scrollbar components 418A-418B. The category component 410 defines a screen area that is used to show more detailed information about the group that menu items belong to. So, for instance, if the items 202A-202N are games, the category component 410 may provide an indication that the currently selected groups is a games group. In this regard, the category component 410 includes an icon 412, a text label 414, and a text description 416. Because the category component 410 provides information about the entire group, the contents of the category component 410 do not change from item to item.

The scrollbar components 418A-418B are utilized to show the relative position of the currently selected item in the ordered list of menu items to which it belongs. Alternatively, the scrollbar components 418A-418B may be used to show the number of items before and after the currently selected item, respectively. A scrollbar may be horizontally oriented, like the scrollbar component 418A, or may be vertically oriented, like the scrollbar component 418B. It should be appreciated that the preview component 204, the category component 410, and the scrollbar component 418 are optional and need no be included in every user interface menu.

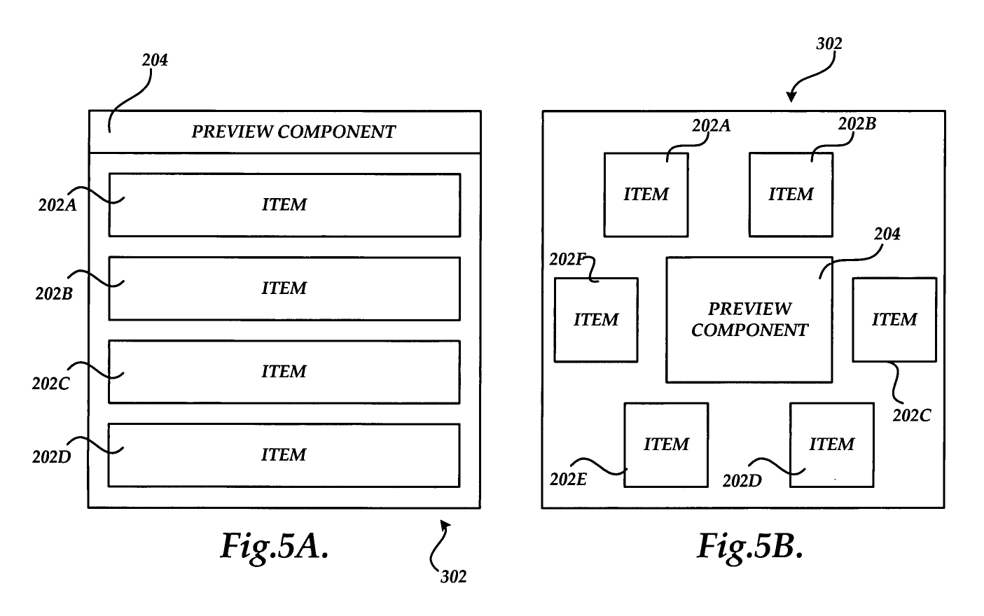

Turning now to FIGS. 5A-5B, several block diagrams showing different arrangements of an items component, items, and a preview component according to various embodiments of the invention will be discussed. In the examples described above, each of the items 202A-202N are oriented in a tiled fashion. It should be appreciated, however, that any layout of items may be created using the embodiments of the present invention. For instance, in FIG. 5A, an items component 302 is displayed that includes items 202A-202D. The items 202A-202D are defined and configured on screen as a sequence of vertically oriented rectangles. In this manner, a traditional list-style menu may be provided. A preview component 204 may also be provided in conjunction with the menu.

FIG. 5B shows another configuration of items 202A-202F and the preview component 204. As shown in FIG. 5B, the preview component 204 is centered in the middle of the display screen. The items 202A-202F are configured in a circular pattern around the preview component 204. In this manner, a unique menu presentation may be provided. It should be appreciated that the items, preview component, category component may be defined on screen in any manner desired by the user to create a limitless number of menu possibilities.

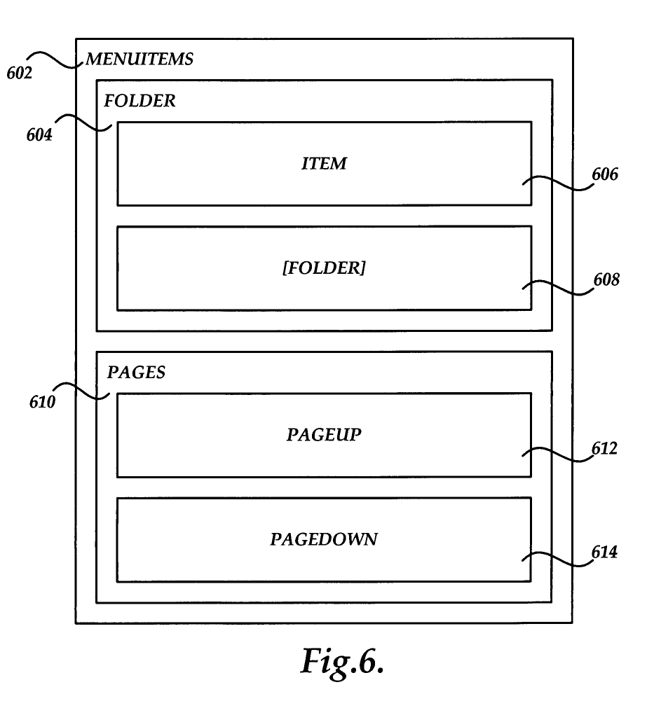

Turning now to FIG. 6, aspects of the contents of the menu definition file 118 will be described. As discussed briefly above, the menu definition file 118 includes data describing the various menu items to be displayed as the menu. The menu data describes the nested hierarchy of items in the menu, along with their attributes (e.g. name or icon graphics). Since a menu typically has more than one level, its data is organized hierarchically in a tree-like structure with root, intermediate, and leaf nodes. The menu data contains only one root not. Leaf nodes in a menu point to actual programs, files, URLs, etc. to be launched from the menu. Intermediate nodes are folders. Between the root node and leaf nodes, there can be any number of intermediate nodes. Each intermediate node usually serves as a grouping of leaf nodes and/or other intermediate nodes underneath it.

According to one embodiment of the invention, XML us utilized to represent the menu data within the menu definition file 118. FIG. 6 illustrates the XML schema for representing the menu data. In particular, the <menuitems> element 602 is the top level container of the menu data. The <menuitems> element 602 must have a <folder> element 604 representing the root node of the menu and a <pages> element 610 representing page continuations. The <folder> element 604 represents either the root or an intermediate node in the menu data. There can be only one <folder> element 608 under the <menuitems> element 602, but any number of <folder> elements 608 may exist under another folder 604. The <folder> element 608 has the elements and attributes shown in TABLE 1.

TABLE 1

| | Description |
|---|---|
| Attribute | |
| hint | Description text |
| icon | Reserved |
| icon-category | Icon to be used in the category component of |
| | presentation UI |
| icon-normal | Icon to be used when item is not selected, in the items |
| | component of presentation UI |
| icon-focus | Icon to be used in the focus when item is selected, in the |
| | items component of presentation UI |
| icon-preview | Icon to be used when item is selected, in the preview |
| | component of presentation UI |
| label | Display text |
| name | Folder name |
| shortcut | Shortcut to launch a program, file, URL, etc., or jump to |
| | another node |
| style | Presentation UI style to be used for items/folders in this |
| | folder |
| Element | |
| item | A leaf node in the menu data |
| folder | Optionally additional folder representing an intermediate |
| | node (i.e., a group of items) in the menu data |

As shown in TABLE 1, the <folder> element 604 may include an “icon-category” attribute that identifies an icon to be displayed in the category component 410, a “icon-normal” attribute that identifies an icon to be displayed in the items component 302 when the folder is not selected, an “icon-focus” attribute that identifies an icon to be displayed in the items component 302 when the folder is selected, and an “icon-preview” attribute that identifies an icon to be displayed in the preview component 204 when the folder is selected. The <folder> element 604, also includes a “label” attribute that provides a text label to be displayed for the folder in the items component 302, a “hint” attribute that provides a text description to be displayed for the folder in the preview component, and a “shortcut” attribute that identifies another node to be displayed if a the folder is selected. The <folder> element also includes a “style” attribute that identifies the presentation UI style to be utilized when presenting the items in the folder. Because the “style” attribute is provided per folder, each folder may be displayed with a different style. Additional details regarding defining styles will be provided below.

The <item> element 606 represents a leaf node in the menu data. As such, there can be any number of <item> elements 606 under a <folder> element 604. The <item> element 606 has the attributes shown in TABLE 2.

TABLE 2

| Attribute | Description |
|---|---|
| hint | Description text |
| icon | Reserved |
| icon-normal | Icon to be used when item is not selected, in the items |
| | component of presentation UI |
| icon-focus | Icon to be used in the focus when item is selected, in the |
| | items component of presentation UI |
| icon-preview | Icon to be used when item is selected, in the preview |
| | component of presentation UI |
| label | Display text |
| name | Item name |
| shortcut | Shortcut to launch a program, file, URL, etc., or jump to |
| | another node |

As shown in TABLE 2, the <item> element 606 may include an “icon-normal” attribute that identifies an icon to be displayed in the items component 302 when the item is not selected, an “icon-focus” attribute that identifies an icon to be displayed in the items component 302 when the item is selected, and an “icon-preview” attribute that identifies an icon to be displayed in the preview component 204 when the item is selected. The <item> element 606, also includes a “label” attribute that provides a text label to be displayed for the item in the items component 302, a “hint” attribute that provides a text description to be displayed for the item in the preview component 204, and a “shortcut” attribute that identifies the action to be performed if a request to execute a selected menu item is received. TABLE 3 shows the contents of an illustrative menu definition file 118 and illustrates the use of the above-described elements and attributes for defining a menu.

```
TABLE 3
<?xml version=“1.0” encoding=“UTF-8” ?>
<menuitems>
  <folder name=“StartMenu” label=“Start Menu” icon-
      category=“cat_mainmenu.bmp” icon-normal=“ ” icon-focus=“ ” icon-
      preview=“ ” shortcut=“ ” hint=“ ” menustyle=“default”>
    <item name=“Appl” label=“Call History” icon-
        normal=“Call_History_32.bmp” icon-preview=“Call_History_32.bmp”
        shortcut=“\Storage\Windows\Start Menu\Call History.Ink”
        hint=“Call History” />
    <item name=“App2” label=“ActiveSync” icon-normal=“ActiveSync_32.bmp”
        icon-preview=“ActiveSync_32.bmp”
        shortcut=“\Storage\Windows\Start Menu\ActiveSync.lnk”
        hint=“ActiveSync” />
    <item name=“App3” label=“Calendar” icon-normal=“Calendar_32.bmp”
        icon-preview=“Calendar_32.bmp” shortcut=“\Storage\Windows\Start
        Menu\Calendar.lnk” hint=“Calendar” />
    ...
    <folder name=“GameFolder” label=“Games” icon-category=“cat_games.bmp”
      icon-normal=“Folder_32.bmp” icon-focus=“ ” icon-
      preview=“Folder_32.bmp” shortcut=“ ” hint=“Games”
      menustyle=“red”>
    <item name=“App12” label=“Links” icon-normal=“Links_32.bmp” icon-
        preview=“Links_32.bmp” shortcut=“\Storage\Windows\Start
        Menu\Games\Links.lnk” hint=“Links” />
    <item neme=“App13” label=“Solitaire” icon-
        normal=“Solitaire_32.bmp” icon-preview=“Solitaire_32.bmp”
        shortcut=“\Storage\Windows\Start Menu\Games\Solitaire.lnk”
        hint=“Solitaire” />
  </folder>
  ...
</folder>
<pages>
  <pageup name=“PageUp” label=“Previous Page” icon-normal=“pageup.bmp”
      icon-focus=“ ” icon-preview=“ ” shortcut=“ ” hint=“Previous Page”
      />
  <pagedown name=“PageDown” label=“Next Page” icon-
      normal=“pagedown.bmp” icon-focus=“ ” icon-preview=“ ” shortcut=“ ”
      hint=“Next Page” />
</pages>
</menuitems>
```

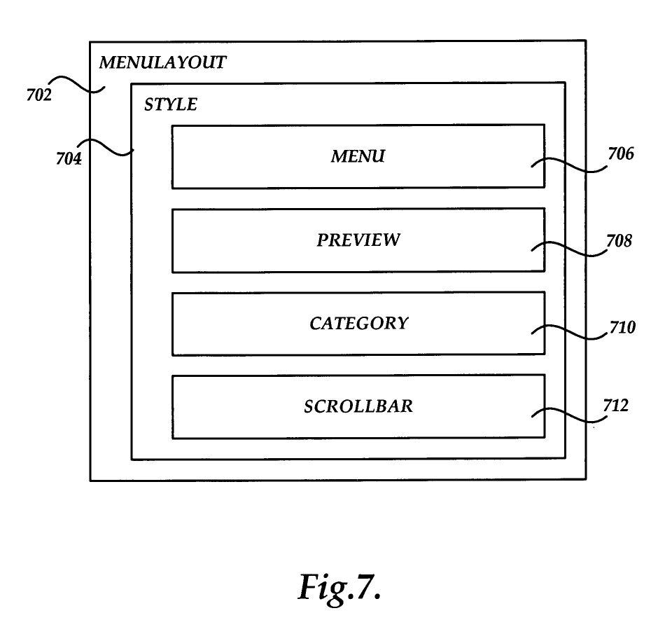

Referring now to FIG. 7, details regarding a <menuitems> XML element will be described. As discussed briefly above, the view definition file 120 stores data defining a style to be utilized when displaying a particular node of the menu defined within the menu definition file 118. In particular, the <menulayout> element 702 is the top level container for the menu presentation UI. The first three levels of the XML hierarchy for the <menulayout> element 702 are illustrated in FIG. 7.

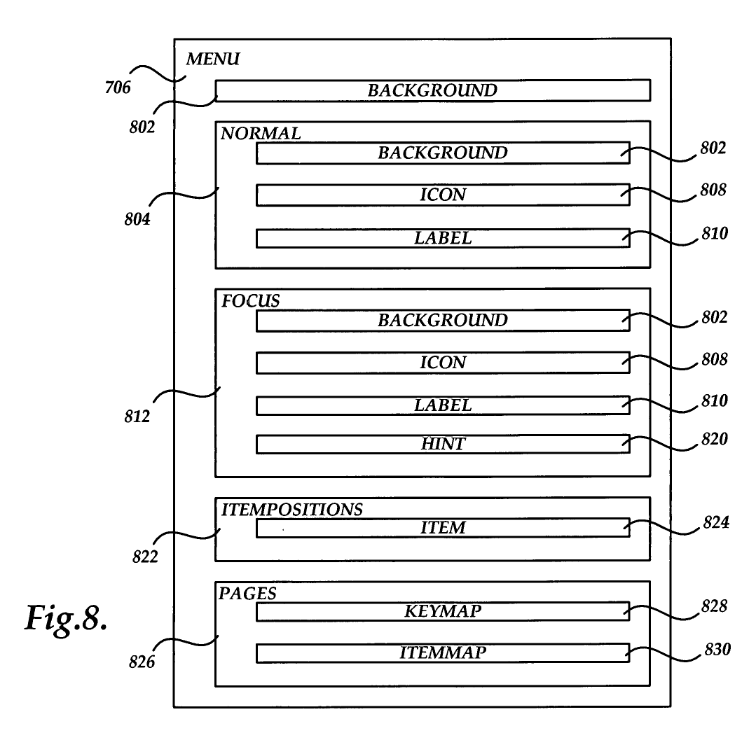

The first layer of the XML hierarchy for the <menulayout> element 702 is the <style> element 704. The <style> element 704 represents a complete set of data for defining the user interface layout and for defining the navigation among items in a menu. There may be more than one <style> element 704. Each <style> element 704 may include a “name” attribute, a <menu> element 706, a <preview> element 708, a <category> element 710, and a <scrollbar> element 712. Each of these elements are discussed in greater detail below with respect to FIG. 8, 9 A, 9 B, 9 C, and 9 D, respectively.

Turning now to FIG. 8, additional details regarding the <menu> element 706 will be described. As shown in FIG. 8, the <menu> element 706 may include a <background> element 802, a <normal> element 804, a <focus> element 812, an <itempositions> element 822, and a <pages> element 826. Each of these elements is described in greater detail below. The <menu> element 706 may also include a “height” attribute that defines the height of the items component bounding box, a “width” element that defines the width of the bounding box, an “x coordinate” attribute that defines the X coordinate, in pixels, of the top left comer of the items component bounding box, and a “y coordinate” attribute that defines the Y coordinate, in pixels, of the items component bounding box.

The <background> element 802 specifies a bitmap image, if any, to be used for the background in a menu layout. The <background> element 802 may include a “bgimage” attribute that specifies the path and filename of the background image file, a “border-width” attribute that specifies the frame width, in pixels, for a border, and a “border-color” attribute that specifies a color for the border.

The <normal> element 804 represents the layout of the items specified in the items component. The <normal> element 804 may include attributes specifying the height and width of a bounding box for the item, in pixels. The <normal> element 804 may also include a <background> element 802, described above, an <icon> element 808, and a <label> element 810. The <icon> element 808 specifies the bounding area of the icon image in a layout. The <icon> element 808 may include attributes specifying the height and width of a bounding box for the icon image, X and Y coordinates of the tope left comer of the bounding box, and whether the icon should be displayed.

The <label> element 810 specifies the bounding area of a text label in a layout. The <label> element 810 may have elements specifying alignment of label text within a bounding box (left, center, right), text color, text font, font size, and font weight. Additionally, the <label> element 810 may have attributes specifying the height and width of a bounding box for the text bounding box, X and Y coordinates of the tope left comer of the bounding box, and indicating whether the text label should be displayed.

The <focus> element 812 defines the focus layout in the items component. The <focus> element 812 includes attributes defining the height and width of the focus layout's bounding box, in pixels. The <focus> element 812 may also include a <background> element 802, an <icon> element 808, and a <label> element 810, all of which are described above. The <focus> element 812 may also include a <hint> element 820, which specifies the bounding area of the description text in a layout. The <hint> element 820 may have elements specifying alignment of description text within a bounding box (left, center, right), text color, text font, font size, and font weight. Additionally, the <hint> element 820 may have attributes specifying the height and width of a bounding box for the text bounding box, X and Y coordinates of the tope left comer of the bounding box, and indicating whether the text description should be displayed.

The <itempositions> element 822 represents item positions in the items component. It has no attributes and contains at least one <item> element 824. The <item> element 824. The <item> element 824 specifies the bounding area of an item in the items component. It includes attributes defining the item's two-dimensional index (for navigation purposes), defining height and width of the bounding box for the item, and defining the pixel coordinates of the top left comer of the bounding box, in pixels.

The <pages> element 826 represents navigation between the items and pages. The <pages> element 826 may include an attribute defining whether pages should be advanced automatically (autoscroll). The <pages> element 826 may also include a <keymap> element 828 and an <itemmap> element 830. The <keymap> element 828 specifies the buttons on the phone keypad that should be used as shortcuts to move to the next or previous page. The <keymap> element 828 may have attributes to turn page acceleration on or off, to identify the button assigned for a page up operation, and to define a button assigned to the page down operation. The <itemmap> element 830 specifies the items on each menu item page that should be used to move to the next or previous page. The <itemmap> element 830 has attributes to turn on or off the icons for page advancement, to identify the item index for page down, and to identify the item index for page up.

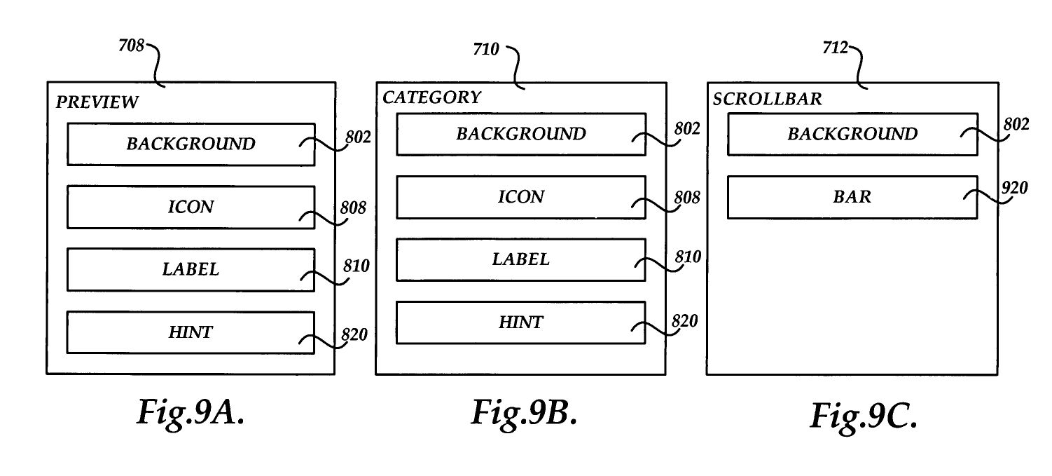

Referring now to FIGS. 9A-9C, additional details regarding the <preview> element 708, the <category> element 710, and the <scrollbar> element 712 will be described. In particular, as shown in FIG. 9A, the <preview> element 708 represents the preview component 204 of the presentation user interface. The <preview> element 708 includes attributes defining the height and width of a bounding box for the preview component 204, the pixel coordinates of the upper left hand comer of the bounding box, and whether the preview component 204 should be displayed. The <preview> element 708 may also include a <background> element 802, a <icon> element 808, a <label> element 810, and a <hint> element 908, all described above.

The <category> element 710 represents the category component 410 in the presentation user interface. The <category> element 710 includes attributes defining the height and width of a bounding box for the category component 410, the pixel coordinates of the upper left hand comer of the bounding box, and whether the category component 410 should be displayed. The <category> element 710 may also include a <background> element 802, a <icon> element 808, a <label> element 810, and a <hint> element 908, all described above.

The <scrollbar> element 712 represents the scrollbar component 418 in the presentation user interface. The <scrollbar> element 712 includes attributes defining whether the scrollbar should be oriented horizontally or vertically, the height and width of a bounding box for the scrollbar component 418, the pixel coordinates of the upper left hand comer of the bounding box, and whether the scrollbar component 418 should be displayed. The <scrollbar> element 712 may also include a <background> element 802, defined above, and a <bar> element 920. The <bar> element 920 specifies the scrollbox within the scrollbar. The <bar> element 920 includes attributes defining a color for the scrollbox and the identity of an image for the scrollbox. TABLES 4 and 5, below, show examples of the various XML elements described above.

```
TABLE 4
<?xml version=“1.0” encoding=“UTF-8” ?>
<menulayout>
  <system author=“Microsoft” version=“1.0” contacturl=“www.microsoft.com” />
  <style name=“default”>
    <menu visible=“1” x=“0” y=“0” w=“176” h=“180”>
      <background border-width=“0” border-color=“#FF0000”
          bgimage=“back_menu.bmp” />
      <normal w=“50” h=“50”>
        <background border-width=“0” border-color=“#000000” bgimage=“ ” />
        <icon visible=“1” x=“9” y=“2” w=“32” h=“32” />
        <label visible “0” x=“0” y=“0” fgcolor=“#FFFFFF” font-size=“8”
            align=“L” font-weight=“normal” />
      </normal>
      <focus w=“50” h=“50”>
        <background border-width=“2” border-color=“#FFFF00” bgimage=“ ” />
        <icon visible=“0” x=“0” y=“0” w=“32” h=“32” />
        <label visible=“1” x=“0” y=“32” w=“50” h=“15” fgcolor=“#FFFFFF” font-
            size=“8” font-weight=“normal” align=“C” />
        <hint visible=“0” x=“0” y=“0” fgcolor=“#FF0000” font-size=“12” font-
            weight=“bold” />
      </focus>
      <itemposition>
        <item idx=“1,1” x=“7” y=“8” w=“50” h=“50” />
        <item idx=“1,2” x=“63” y=“8” w=“50” h=“50” />
        <item idx=“1,3” x=“119” y=“8” w=“50” h=“50” />
        <item idx=“2,1” x=“7” y=“65” w=“50” h=“50” />
        <item idx=“2,2” x=“63” y=“65” w=“50” h=“50” />
        <item idx=“2,3” x=“119” y=“65” w=“50” h=“50” />
        <item idx=“3,1” x=“7” y=“122” w=“50” h=“50” />
        <item idx=“3,2” x=“63” y=“122” w=“50” h=“50” />
        <item idx=“3,3” x=“119” y=“122” w=“50” h=“50” />
      </itemposition>
        <pages autoscroll=“0”>
        <keymap enable=“1” pageup=“*” pagedown=“#” />
        <itemmap enable=“1” pageup=“1,1” pagedown=“3,3” />
      </pages>
    </menu>
  </style>
</menulayout>
```

```
TABLE 5
<?xml version=“1.0” encoding=“UTF-8” ?>
<menulayout>
  <system author=“Microsoft” version=“1.0” contacturl=“www.microsoft.com” />
  <style name=“default”>
    <menu visible=“1” x=“0” y=“90” w=“176” h=“90”>
      <background border-width=“0” border-color=“#FFFFFF”
          bgimage=“back_menu.gif” />
      <normal w=“36” h=“36”>
        <background border-width=“0” border-color=“#FFFFFF” bgimage=“ ” />
        <icon visible=“1” x=“2” y=“2” w=“32” h=“32” />
        <label visible=“0” x=“0” y=“0” fgcolor=“#FFFFFF” font-size=“8”
            align=“L” font-weights=“normal” />
      </normal>
      <focus w=“36” h=“36”>
        <background border-width=“2” border-color=“#0000FF” bgimage=“ ” />
        <icon visible=“0” x=“2” y=“2” w=“32” h=“32” />
        <label visible=“0” x=“0” y=“0” fgcolor=“#FFFFFF” font-size=“8” font-
            weight=“normal” align=“C” />
        <hint visible=“0” x=“10” y=“10” fgcolor=“#FFFFFF” font-size=“12” font-
            weight=“bold” />
      </focus>
      <itemposition>
        <item idx=“1,1” x=“17” y=“6” w=“36” h=“36” />
        <item idx=“1,2” x=“70” y=“6” w=“36” h=“36” />
        <item idx=“1,3” x=“123” y=“6” w=“36” h=“36” />
        <item idx=“2,1” x=“17” y=“48” w=“36” h=“36” />
        <item idx=“2,2” x=“70” y=“48” w=“36” h=“36” />
        <item idx=“2,3” x=“123” y=“48” w=“36” h=“36” />
      </itemposition>
      <pages autoscroll=“1”>
        <keymap enable=“1” pageup=“*” pagedown=“#” />
        <itemmap enable=“1” pageup=“1,1” pagedown=“2,3” />
      </pages>
    </menu>
    <preview visibles=“1” x=“0” y=“0” w=“176” h=“90”>
      <background border-width=“0” border-color=“#FFFFFF”
          bgimage=“preview1.jpg” />
      <icon visible=“1” x=“17” y=“10” w=“32” h=“32” size=“32” />
      <label visible=“1” x=“57” y=“10” w=“99” h=“18” fgcolor=“#FFFF80” font-
          size=“12” font-weight=“bold” align=“L” />
      <hint visible=“1” x=“57” y=“32” w=“99” h=“50” fgcolor=“#FFFFFF” font-
          size=“10” font-weights=“normal” align=“L” />
    </preview>
  </style>
  <style name=“red”>
    <menu visible=“1” x=“0” y=“90” w=“176” h=“90”>
      <background border-width=“0” border-color=“#FFFFFF”
          bgimage=“back_menu.gif” />
      <normal w=“36” h=“36”>
        <background border-width=“0” border-color=“#FFFFFF” bgimage=“ ” />
        <icon visible=“1” x=“2” y=“2” w=“32” h=“32” />
        <label visible=“0” x=“0” y=“0” fgcolor=“#FFFFFF” font-size=“8”
            align=“L” font-weight=“normal” />
      </normal>
      <focus w=“36” h=“36”>
        <background border-width=“2” border-color=“#FF0000” bgimage=“ ” />
        <icon visible=“0” x=“2” y=“2” w=“32” h=“32” />
        <label visible=“0” x=“0” y=“0” fgcolor=“#FFFFFF” font-size=“8” font-
            weight=“normal” align=“C” />
        <hint visible=“0” x=“10” y=“10” fgcolor=“#FFFFFF” font-size=“12” font-
            weight=“bold” />
      </focus>
      <itemposition>
        <item idx=“1,1” x=“17” y=“6” w=“36” h=“36” />
        <item idx=“1,2” x=“70” y=“6” w=“36” h=“36” />
        <item idx=“1,3” x=“123” y=“6” w=“36” h=“36” />
        <item idx=“2,1” x=“17” y=“48” w=“36” h=“36” />
        <item idx=“2,2” x=“70” y=“48” w=“36” h=“36” />
        <item idx=“2,3” x=“123” y=“48” w=“36” h=“36” />
      </itemposition>
      <pages autoscroll=“1”>
        <keymap enable=“1” pageup=“*” pagedown=“#” />
        <itemmap enable=“1” pageup=“1,1” pagedown=“2,3” />
      </pages>
    <menu>
    <preview visible=“1” x=“0” y=“0” w=“176” h=“90”>
      <background border-width=“0” border-color=“#FFFFFF”
          bgimage=“preview2.jpg” />
      <icon visible=“1” x=“17” y=“10” w=“32” h=“32” size=“32” />
      <label visible=“1” x=“57” y=“10” w=“99” h=“16” fgcolor=“#FF0000” font-
          size=“12” font-weight=“bold” align=“L” />
      <hint visible=“1” x=“57” y=“28” w=“99” h=“50” fgcolor=“#FFFFFF” font-
          size=“10” font-weight=“normal” align=“L” />
    </preview>
  </style>
</menulayout>
```

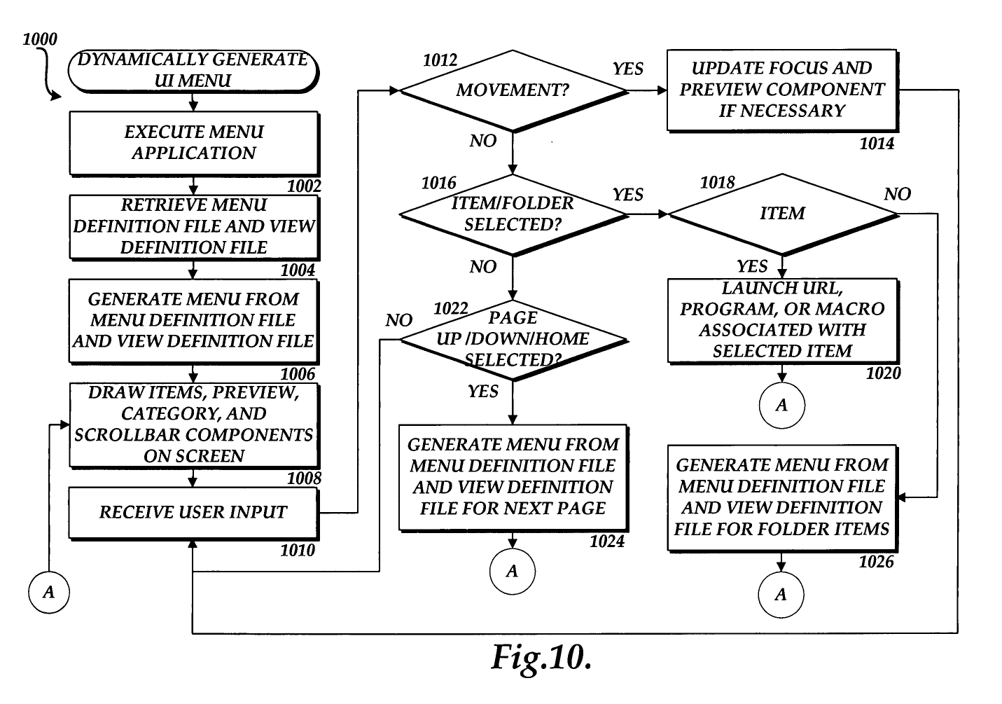

Referring now to FIG. 10, an illustrative routine 1000 will be described illustrating a process performed by the menu application 112 for dynamically providing a user interface menu. When reading the discussion of the routines presented herein, it should be appreciated that the logical operations of various embodiments of the present invention are implemented (1) as a sequence of computer implemented acts or program modules running on a computing system and/or (2) as interconnected machine logic circuits or circuit modules within the computing system.

The implementation is a matter of choice dependent on the performance requirements of the computing system implementing the invention. Accordingly, the logical operations illustrated in FIG. 10, and making up the embodiments of the present invention described herein, are referred to variously as operations, structural devices, acts or modules. It will be recognized by one skilled in the art that these operations, structural devices, acts and modules may be implemented in software, in firmware, in special purpose digital logic, and any combination thereof without deviating from the spirit and scope of the present invention as received within the claims attached hereto.

The process 1000 begins at operation 1002, where the menu application 112 is executed. As described briefly above, the menu application 112 may be executed when the handheld device 100 is powered on. Alternatively, the functionality provided by the menu application 112 may be integrated into the operating system 110. From operation 1002, the process 1000 continues to operation 1004, where the menu definition file 118 and the view definition file 120 are retrieved by the menu application 112. The routine then continues from operation 1004 to operation 1006.

At operation 1006, the menu application 112 generates the menu from the contents of the menu definition file 118 and the view definition file 120. In particular, at operation 1008, the menu application 112 displays the items component 302, preview component 204, category component 410, and scrollbar components 418A-B on screen as specified in the menu definition file 118 and the view definition file 120. The process 1000 then continues to operation 1010 where user input is received via key input, via a touch screen, or via another type of input device. The process 1000 then continues to operation 1012.

At decision operation 1012, the menu application 112 determines whether user input was received moving the currently selected item. If the currently selected item was moved, the process 1000 branches to operation 1014, where the focus component 310 is updated. If a preview component 204 is being displayed, the preview component 204 will also be updated. The process 1000 then returns to operation 1010 where user input is again received.

If, at operation 1012, the menu application 112 determines that user input moving the currently selected item was not received, the process 100 continues to operation 1016. At operation 1016, the menu application 112 determines whether input was received selecting either an item or a folder. If such input was received, the process 1000 branches to operation 1018, where the menu application 112 determines whether an item was selected. If an item was selected, the process 1000 continues to operation 1020, where the shortcut associated with the selected item is returned to the shell and executed. In this manner, the URL, macro, or program identified in the shortcut can be executed.

If, at operation 1018, the menu application determines that input was not received selecting an item, the process 1000 branches to operation 1026. At operation 1026, the menu application 112 determines that a folder was selected and generates a new menu display from the menu definition file 118 and the view definition file 120 for the newly selected folder node. The process 1000 then returns to operation 1008, where the items component 302, preview component 204, category component 410, and scrollbar components 418A-B are displayed on screen.

If, at operation 1016, the menu application 112 determines that neither a folder or item has been selected, the process 1000 continues to operation 1022. At operation 1022, the menu application 112 determines whether a shortcut key was selected for navigating between nodes of the menu. For instance, the page up, page down, or home keys may be selected for this purpose. If one of these keys was selected, the process 1000 continues to operation 1024, described above. If one of these keys was not selected, the routine 1000 returns to operation 1010, where additional user input may be received.

Based on the foregoing, it should be appreciated that the various embodiments of the invention include a method, system, apparatus, and computer-readable medium for dynamically generating a user interface menu. The above specification, examples and data provide a complete description of the manufacture and use of the composition of the invention. Since many embodiments of the invention can be made without departing from the spirit and scope of the invention, the invention resides in the claims hereinafter appended.

1. A method for dynamically generating a user interface menu, the method comprising:
storing a menu definition file containing data describing one or more menu items to be displayed as the menu;
storing a view definition file separate from the menu definition file, the view definition file containing data describing how the menu should appear when displayed; and
utilizing the contents of the menu definition file and the view definition file to dynamically generate the menu.

2. The method of claim 1, wherein the menu comprises an items component for displaying each of the one or more menu items.

3. The method of claim 2, wherein the menu further comprises a preview component for displaying a preview corresponding to a currently selected menu item.

4. The method of claim 3, wherein the menu further comprises a category component for displaying information corresponding to a group of menu items.

5. The method of claim 4, wherein for each of said one or more menu items the menu definition file stores data identifying a graphic that should be displayed for the menu item in the items component when the menu item is unselected.

6. The method of claim 5, wherein for each of said one or more menu items the menu definition file stores data identifying a graphic that should be displayed in the preview component when a menu item is selected.

7. The method of claim 6, wherein for each of said one or more menu items the menu definition file stores a text label to be displayed for each menu item in the items component.

8. The method of claim 7, wherein for each of said one or more menu items the menu definition file stores a text description to be displayed for each menu item in the preview component.

9. The method of claim 8, wherein for each of said one or more menu items the menu definition file stores data identifying an action to be performed if a request to execute a selected menu item is received.

10. The method of claim 9, wherein said one or more menu items may comprise an item or a folder.

11. The method of claim 10, wherein the view definition file stores data defining a style to be utilized when displaying the menu defined within the menu definition file.

12. The method of claim 11, wherein the style comprises data identifying a background image to be utilized within the items component.

13. The method of claim 12, wherein the style further comprises data defining an on screen position for each of the menu items within the items component.

14. The method of claim 13, further comprising receiving an updated menu definition file and an updated view definition file and replacing the menu definition file with the updated menu definition file and replacing the view definition file with the updated view definition file.

15. The method of claim 14, wherein the updated menu definition file and the updated view definition file are received via a wireless connection.

16. The method of claim 14, wherein the updated menu definition file and the updated view definition file are received via a memory device.

17. A computer-readable medium having computer-executable instructions stored thereon which, when executed by a computer, will cause the computer to perform the method of claim 1.

18. A computer-controlled apparatus capable of performing the method of claim 1.
